(19) United States
(12) Patent Application Publication
(10) Pub. No.: US 2010/0323571 A1
(43) Pub. Date: Dec. 23, 2010

(54) APPLICATION OF MATERIALS TO FORM A MULTI-LAYER PRODUCT

(75) Inventor: David Hawes, Raleigh, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Richmond, VA (US)

(21) Appl. No.: 12/918,646

(22) PCT Filed: Mar. 25, 2009
(86) PCT No.: PCT/US09/38182

§ 371 Date: Aug. 20, 2010

Related U.S. Application Data
(63) Continuation-in-part of application No. 61/041,258, filed on Apr. 1, 2008.

(51) Int. Cl. B32B 5/16; B05D 3/10; B05D 1/04; B32B 27/36; B32B 27/00; B32B 15/04; B32B 29/00

(52) U.S. Cl. 442/59; 427/301; 427/475; 428/480; 428/500; 428/457; 428/537.5

(57) ABSTRACT

A method of producing a multi-layer product that includes an extruded polymeric layer comprising an enhancer composition is disclosed. The disclosed product is produced by applying an enhancer composition (25) onto a transfer surface (22), such as that of a chill roll (12) on an extruder station (10), and then contacting the applied transfer surface against molten polymer (24) either before or during extrusion process of the molten polymer onto a substrate (20). The enhancer composition may impart functional and/or decorative properties to the treated substrate. When desired, the enhancer composition may be applied onto the transfer surface using an electrostatic spraying device.

This non-provisional application relies on the filing date of provisional U.S. Application Ser. No. 61/041,258 filed on Apr. 1, 2008, which is incorporated herein by reference, having been filed within twelve (12) months thereof, and priority thereto is claimed under 35 USC §1.19(e).

### BACKGROUND OF THE DISCLOSURE

Extrusion coating is the coating of a molten web of resin on to a substrate material. It has gained major importance in the past 20 years as a means to incorporate functional coating onto the substrate. Furthermore, extrusion coating is a versatile and economical coating technique that is suitable for a variety of substrates, including paperboard, paper, aluminium foils, cellulose and plastic films. The market for extrusion coating includes a variety of end-use applications, such as liquid packaging, flexible packaging, sack linings, mill and industrial wrappings, transport packaging, photographic, and other commercial applications.

FIG. 1 shows the extrusion coating process known in the art. An extruder station 10 has an extruder 18 that includes a slot die 19 and contains molten resin 24; a chrome plated cooling chill roll 12 with surface 22, and a rubber covered pressure roll 14. The molten resin 24 is extruded from the slot die 19 directly onto a moving web substrate 20 which is then passed through a nip consisting of the chill roll 12 and the pressure roller 14. The nip presses the resin coating onto the substrate 20 to ensure complete contact and adhesion. The chill roll 12 cools the molten resin back into the solid film on the surface of the substrate 20.

Paperboard is typically produced with a variety of materials and coatings that provide enhanced properties selected for the finished paperboard product. In accordance with conventional manufacturing techniques, these functional coatings and materials are typically added on the paperboard on-line during the papermaking process or off-machine to the formed paperboard. Each method of providing functionalized materials or coatings on paperboard products is associated with certain inherent advantages and disadvantages that are well understood by one of ordinary skilled in the art. Since large amounts of paper are produced for each papermaking process run, applying functional coatings on-line during the papermaking process will provide large volumes and tonnages of the finished coated paper product. Therefore, the on-line coating of the specialized coatings for custom jobs is impractical to warrant the time and material waste involved in changeover on the paper machine. One further problem associated with the on-line coating operations is the impact on recycling that various coatings and/or additives may have on the papermaking process.

Paper or paperboard products used for packaging typically include a layer of polymeric material to provide necessary functional properties for the finished package. Extrusion coating is a frequently used method to apply polymer films to a paper or paperboard. Examples of such functional properties are improved handling and durability; water resistance; resistance to grease, water vapor, and gases; high stability; and flexibility in heat sealing. Adhesion between the polymer film and the paper or paperboard substrate must be sufficient to withstand subsequent converting and in-use requirements. During the extrusion process, the polymer adheres to the substrate both through establishing a chemical bond and by mechanically locking around the fibers on the surface of the substrate. Unfortunately, to achieve the desired performance, the extruded resin is generally a blend of at least two polymeric materials having specific properties to provide satisfactory substrate coating and adhesion, as well as impart desired performance to the coated substrate.

PCT Patent Publication No. 99/50066 describes a packaging material having excellent oxygen barrier performance and enhanced tensile strength. The material is produced by co-extrusion coating onto paper-based substrate, a gas barrier layer of a polyamide blend comprising Nylon-MXD6 polyamide and a second crystalline or semicrystalline polyamide. It is reported that when Nylon-MXD6 polyamide alone is used as the extruded resin, the resulting extrusion-coated substrate has inadequate barrier performance toward gases and liquids for many packaging applications.

U.S. Patent Publication No. 2009/0004489 discloses a paper-based material having good chemical properties and barrier performance. The material is produced by co-extrusion coating onto paper-based substrate, a multimodal polymer composition consisting of (i) a polymer A having a weight average molecular weight of lower than 6000 g/mol; (ii) a polyolefin having a higher weight average molecular weight than polymer A; and (iii) a filler.

The conventional methods of enhancing the properties of the extruded polymeric layer could be impracticable and often cost prohibitive because of the issues associated with modifying the polymer composition, as well as the time and expense involved in changing over from one polymer composition to another. It would be beneficial if the desired properties could be provided by a process that would not entail changing the extruded polymer composition.

Accordingly, there is still the need for a method of applying a functionalized composition onto the substrate that is simple and economical for a customized production scale, yet provides ease of tailoring the coating to achieve the finished coated products with desired performance for the particular end-use application.

Decorative plastic laminate is a durable flat sheeting material used in home and industrial furnishings. It is commonly used to surface kitchen counters, table tops, cabinetry, and automobile interiors because of its durability and aesthetic effect. The decorative laminate sheet can be made in different grades or thicknesses, depending on its intended use. The decorative laminate sheet is made up of three layers: a bottom layer of brown paper coated with a polymeric resin, a top layer of clear protective resinous sheet, and a sandwiched middle layer of decorative paper printed with the color or design that shows the desired surface pattern through the clear top layer. This conventional process of producing decorative plastic sheet is time-consuming and burdensome when the demand for that particular design pattern of the decorative sheet is relatively small. Therefore, the price for customized and the so called “designer” decorative sheets are very high in order to off-set the intensive production cost.

Accordingly, it is beneficial to have a method of producing a decorative laminate sheet that is suitable for customized-scale production.

### SUMMARY OF THE DISCLOSURE

A method of producing a multi-layer product that includes an extruded polymeric layer comprising an enhancer composition is disclosed. The disclosed product is produced by applying an enhancer composition onto a transfer surface, such as that of a chill roll on an extruder station, and then contacting the applied transfer surface against the molten polymer either before or during extrusion process of the molten polymer onto a substrate. The enhancer composition may impart functional and/or decorative properties to the treated substrate. When desired, the enhancer composition may be applied onto the transfer surface using an electrostatic spraying device.

### BRIEF DESCRIPTION OF THE DRAWINGS

FIG. 1 shows a diagrammatic view of an extruder station known in the art; and

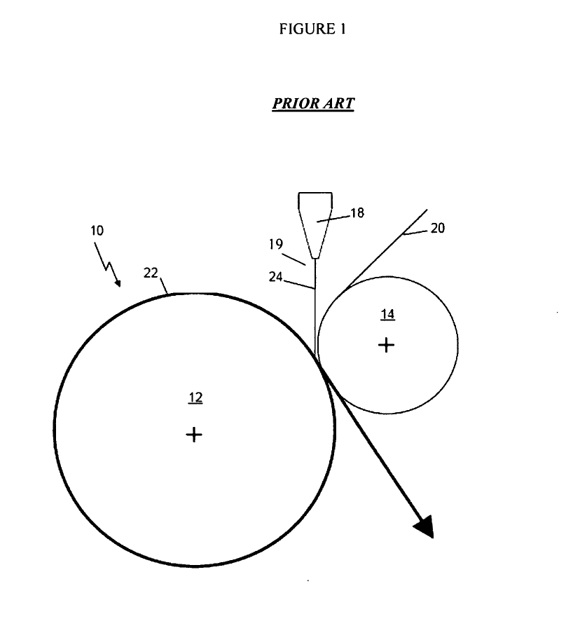

FIG. 2 shows a diagrammatic view of an extruder station in accordance with one embodiment of the present disclosure.

### DETAILED DESCRIPTION OF THE DISCLOSURE

The present disclosure now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

The method of producing a multi-layer product of the present disclosure comprises steps of:

(a) applying an enhancer composition onto a transfer surface;

(b) contacting the applied transfer surface against a molten polymer; and

(c) applying the molten polymer onto a substrate.

In one embodiment, the disclosed method of producing a multi-layer product comprises steps of:

(a) applying an enhancer composition onto a transfer surface

(b) contacting the applied transfer surface against a molten polymer; and

(c) extruding the molten polymer onto a substrate.\

The enhancer composition may be applied onto the transfer surface by several techniques. For example, a variety of spray coating techniques may be used. These includes, but are not limited to, electrostatic spray coating, air atomized spray coating, mechanically atomized spray coating, or ultrasonic spray coating. In one embodiment of the present disclosure, the enhancer composition may be applied onto the moving transferred surface using electrostatic spraying. When desired, more than one spray device may be used for applying the enhancer composition on the transfer surface. The resulting spray patterns may be overlapped to provide uniformity of coverage. The spray devices may be installed in any orientation to apply spray to the transfer surface. For example, the spray device may be located above or below the moving transfer surface. A combination of the aforementioned spraying methods may be used.

The transfer surface may be a rotating roller such as the chill roll of an extruder station. In one embodiment, the disclosed method of producing a multi-layer product comprises steps of:

(a) applying an enhancer composition onto a surface of a rotating roller;

(b) contacting the applied surface of the rotating roller against a molten polymer; and

(c) applying the molten polymer onto a substrate.

In one embodiment, the disclosed method of producing a multi-layer product comprises steps of:

(a) applying an enhancer composition onto a surface of a chill roll;

(b) contacting the applied surface of the chill roll against a molten polymer; and

(c) applying the molten polymer onto a substrate.

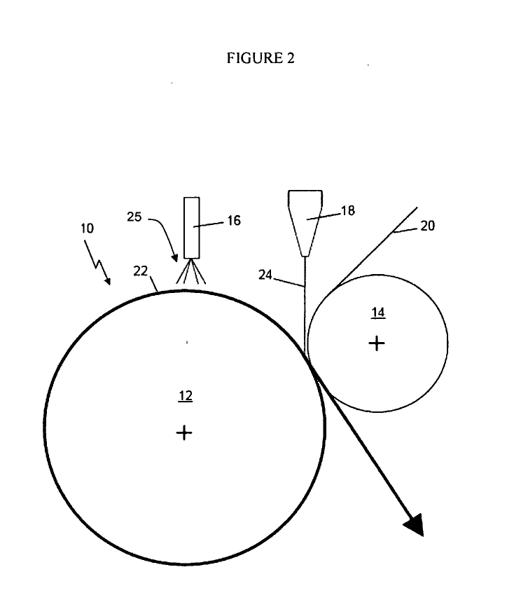

FIG. 2 shows one embodiment of the disclosed method of producing a multi-layer product having an enhancer composition on its surface. An extruder station 10 has a chill roll 12 with a surface 22, a pressure roll 14, a spray device 16 containing an enhancer composition 25, and an extruder 18 containing molten polymer 24. The spray device 16 may be an electrostatic spraying device. In operation, a substrate web 20 advances through the extruder station 10 by moving between the pressure roll 14 and the chill roll 12. The pressure roll 14 presses the substrate web 20 against the chill roll 12. The spraying device 16 applies the enhancer composition 25 onto the surface 22 of the chill roll 12. The applied composition 25 on the surface 22 is advanced in the direction of the nip formed between the pressure roll 14 and the chill roll 12 where it comes into contact with molten polymer 24 from the extruder 18. As the applied composition 25 on the surface web 22 comes in contact with the molten polymer 24, it is laminated to the substrate 20 in the nip between the chill roll 12 and the pressure roll 14.

The enhancer materials may remain on the surface of the extruded polymer layer or be integrated into the polymer layer either completely or to a limited extent. Those skilled in the art can readily determine the desired level and the required adjustments to optimize the extent of migration of the enhancer materials into the polymer. Examples of such adjustments include, but are not limited to, the nip pressure, the extruded polymer, and the enhancer materials. Furthermore, the relative locations between the applicator of the enhancer material and the molten polymer layer may be varied to modify the extent which the enhancer material is integrated with the polymer layer.

The enhancer compositions may be applied at a wide range of coating weights, depending on the end-use applications of the finished multi-layer products.

The enhancer composition may include a chemical material capable of imparting functional performance and/or decorative property to the disclosed multi-layer product. Such materials may be selected based upon the desired characteristics in the finished multi-layer product. When desired, the enhancer composition may further include an additional leveling additive, such as surfactants and rheology modifiers, to impart pseudoplastic or thixotropic flow to the coatings. Additionally, the enhancer composition may include a particle to impart lower thermal conductivity to the multi-layer product. One of ordinary skilled in the art can readily determine and adjust the appropriate amount of the enhancer composition to be applied onto the transfer surface.

The functional material in the enhancer composition may be for a variety of functional properties. These include, but are not limited to, barrier performance, tearing strength, and sealing ability. Any known functional coatings may be included in the enhancer composition. In one embodiment of the present disclosure, the functionalized material comprises a barrier coating. Examples of the barrier coatings useful in the present disclosure include, but are not limited to, those disclosed in U.S. Pat. Nos. 4,421,825; 5,153,061; U.S. Patent Application Publication No. 2004/0241475 and International Publication No. WO 01/17771.

The enhancer composition may include a decorative material to impart decorative effect onto the treated substrate. A wide range of decorative materials may be used in the present disclosure. These include, but are not limited to, white, colored and interference pearlescent pigments such as micro or flat particles coated with metal oxide; flat particles of thin layered plastic that gives interference colors; coated metal foil or metallized particles in silver or various colors; natural and synthetic fibers in various colors; small paper or plastic chip; stone chips; metal particles; relatively small eye-catching particles, chips, or flakes; and combinations thereof.

A variety of substrates suitable for an extrusion process may be used in the present disclosure. These include, but are not limited to, paper-based substrates such as paper and paperboard; metal foils such as aluminum foil; plastic films such as biaxially-oriented polypropylene (BOPP), biaxially-oriented nylon, polyester and the like; cotton cloth; woven fabrics; jute fabric; felted fibrous sheet; matted fibrous sheet; glass fiber mat; metal sheet; flexible foams and combinations thereof. The thickness of the substrate may be varied depending on the particular product to be made and the particular subsequent use for which it is intended. When desired, the substrate web may be pretreated prior to the extrusion process to facilitate the adhesion of the extruded polymeric film onto the substrate. For example, the substrate may be subjected to a surface activating station, where the surface is activated by means of corona and/or flame treatment.

For the paper-based substrates, any conventional paper or paperboard typically used for production of paperboard products or packages may be used. These include, but are not limited to, bleached board, unbleached board, coated bleached board, coated unbleached board, folding board, and recycled board. The paper or paperboard substrate may be made from pulp fibers derived from hardwood trees, softwood trees, or a combination of hardwood and softwood trees prepared for use in a papermaking finish by any known suitable process. The fiber pulps may be bleached or unbleached. When desired, recycled pulp fibers may be used. The basis weight of the paperboard substrate may be varied depending on the desired end-use applications of the finished products.

Molten polymers for use in the present disclosure include those having properties suitable for extrusion coating. Examples of know polymers for extrusion coatings include, but are not limited to, polyolefins such as polyethylene and polypropylene; polyesters such as polyethylene terephthalate (PET); polyamides; polylactic acid (PLA); polyvinyl chloride; polyvinyl acetate; vinyl chloride-vinylidene chloride; ethyl cellulose; polymethyl methacrylate; polyurethane; acrylic; styrenic; polycarbonate; and blends thereof.

The disclosed multi-layer products produced may be used as packaging materials in various market segments. These include, but not limited to, consumer electronics, liquor and other beverages, food, hardware, sporting goods, personal care, medical devices, and pharmaceuticals.

While the disclosure has been described by reference to various specific embodiments, it should be understood that numerous changes may be made within the spirit and scope of the inventive concepts described. It is intended that the disclosure not be limited to the described embodiments, but will have full scope defined by the language of the following claims.

1. A method of producing a multi-layer product comprising steps of:
(a) applying an enhancer composition onto a transfer surface;
(b) contacting the applied transfer surface against a molten polymer; and
(c) applying the molten polymer onto a substrate.

2. The method of claim 1, wherein the enhancer composition is applied by spraying onto the transfer surface.

3. The method of claim 2, wherein the enhancer composition is applied by electrostatically spraying onto the transfer surface.

4. The method of claim 1, wherein the transfer surface is a rotating roller.

5. The method of claim 4, wherein the rotating roller is a chill roll.

6. The method of claim 1, wherein the enhancer composition comprises a functionalized material, a decorative material, or combinations thereof.

7. The method of claim 6, wherein the enhancer composition further comprises a leveling additive.

8. The method of claim 6, wherein the enhancer composition further comprises a particle capable of reducing thermal conductivity.

9. The method of claim 6, wherein the functionalized material comprises a barrier coating.

10. The method of claim 6, wherein the decorative material comprises a material selected from the group consisting of pigments, plastic particles, metal foil, metal particles, natural fibers, synthetic fibers, paper chip, plastic chips, stone chips, and combinations thereof.

11. The method of claim 1, wherein the molten polymer is applied onto the substrate by extrusion.

12. The method of claim 1, wherein the molten polymer comprises a material selected from the group consisting of polyolefins; polyesters; polyamides; polylactic acid; polyvinyl chloride; polyvinyl acetate; vinyl chloride-vinylidene chloride; ethyl cellulose; polymethyl methacrylate; polyurethane; acrylics; styrenics; polycarbonate; and blends thereof.

13. The method of claim 1, wherein the molten polymer comprises polyethylene terephthalate.

14. The method of claim 1, wherein the substrate comprises a material selected from the group consisting of paper-based substrates; metal foils; plastic films; cotton cloth; woven fabrics; jute fabric; felted fibrous sheet; matted fibrous sheet; glass fiber mat; metal sheet; flexible foams; and combinations thereof.

15. The method of claim 1, wherein the substrate includes paperboard or paper.

16. A multi-layered product produced by the method of claim 1.

17. (canceled)

18. (canceled)

19. (canceled)

20. (canceled)

21. (canceled)

22. (canceled)

23. (canceled)

24. (canceled)

25. A packaging material including the multi-layer product of claim 16.
